(19) United States
(12) Patent Application Publication
(10) Pub. No.: US 2016/0218336 A1
(43) Pub. Date: Jul. 28, 2016

(54) METHOD AND APPARATUS FOR ASSEMBLING CELLS IN A BATTERY PACK TO CONTROL THERMAL RELEASE

(71) Applicant: MOTOROLA SOLUTIONS, INC, SCHAUMBURG, IL (US)

(72) Inventors: AMY T. HERRMANN, SUWANEE, GA (US); JOHN E. HERRMANN, SUWANEE, GA (US); EDMOND LOUIE, SNELLVILLE, GA (US); MARK C. TARABOULOS, DUNWOODY, GA (US); MARK J. TERRANOVA, ALGONQUIN, IL (US)

(21) Appl. No.: 14/607,813

(22) Filed: Jan. 28, 2015

(51) Int. Cl. H01M 2/12; H01M 2/10

(52) U.S. Cl. CPC H01M 2/1252; H01M 2/1022; H01M 2/1094

(57) ABSTRACT

A battery pack includes one or more battery cells disposed in a barrier structure that forms a flow channel to direct venting material from a battery cell experiencing a fault condition out of the battery pack in a way that allows expansion of the vented gas before it exits the battery pack. Where two or more battery cells are included in the battery pack, the barrier structure electrically and thermally insulates them from each other so that in the event of a battery cell venting, it will not affect other battery cells and cause a thermal runaway condition.

### FIELD OF THE DISCLOSURE

The present disclosure relates generally to battery packaging arrangements, and more particularly to the consideration of one or more battery cells experiencing a thermal runaway condition.

### BACKGROUND

Mobile and portable electronic products rely on a battery as a power source. The battery includes one or more battery cells assembled in a package that allows the battery cells to be recharged, and typically allows the battery to be removed from a device it is used to power. The battery plays a critical role in the form factor, size and weight of these electronic products.

The use of lithium ion batteries has grown in popularity due to advantages over other cell technologies such as high energy density and low rate of self-discharge. The high energy density allows lithium ion cells to be used in a variety of different applications ranging from portable electronic radios to electric vehicles while minimizing the overall weight and size of the system (device and battery) compared to more mature battery chemistries such as nickel-based rechargeable batteries (e.g. nickel-cadmium, nickel metal hydride).

Product designs incorporating lithium ion cells should take into account robustness and safe current, voltage, and temperature operating limits. As lithium ion cells continue to increase in energy density, upon a failure of a battery cell, there is a corresponding increase in the release of energy, at high temperatures, of battery cell material upon a catastrophic failure. The newer, higher energy density cells increase the potential danger of such a thermal runaway event. Thermal runaway refers to a situation where an increase in temperature changes the conditions in a way that causes a further increase in temperature, often leading to a destructive result. Thermal runaway of a single lithium ion cell can lead to a cascade of catastrophic cell failures in multi-cell packs.

Accordingly, it would be desirable to have an improved battery pack design which addresses the above issues while minimizing the impact on battery pack size and weight.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an isometric view of a battery cell having a pressure vent, in accordance with the prior art;

FIG. 2 is top cut-away plan view of a battery pack in accordance with some embodiments;

FIG. 3 is a multi-view diagram of a battery pack containing commonly oriented battery cells in accordance with some embodiments;

FIG. 4 is a top cut-away plan view of a battery pack having baffle walls in a flow channel in accordance with some embodiments;

FIG. 5 is an external view of a battery pack having a label that covers a housing vent in accordance with some embodiments; and

FIG. 6 is battery pack including a plurality of sub-units where each sub-unit includes one or more battery cells and corresponding flow channel, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments exemplified by the following discussion include a battery pack that is thermally protected against battery cell faults that cause thermal venting which can affect other battery components, including inducing similar faults in adjacent battery cells in some embodiments. The battery pack includes at least one battery cell having a pressure vent that is disposed in a barrier structure formed around at least one battery cell. The barrier structure is comprised of a thermally resistant material, and forms a vent channel in proximity to the pressure vent of the at least one battery cell. The battery pack further includes a housing in which at least one battery and barrier structure are disposed. The housing includes a housing wall that is configured to form a flow channel between the housing wall and the barrier structure from the vent channel of the barrier structure to a housing vent formed in the housing wall.

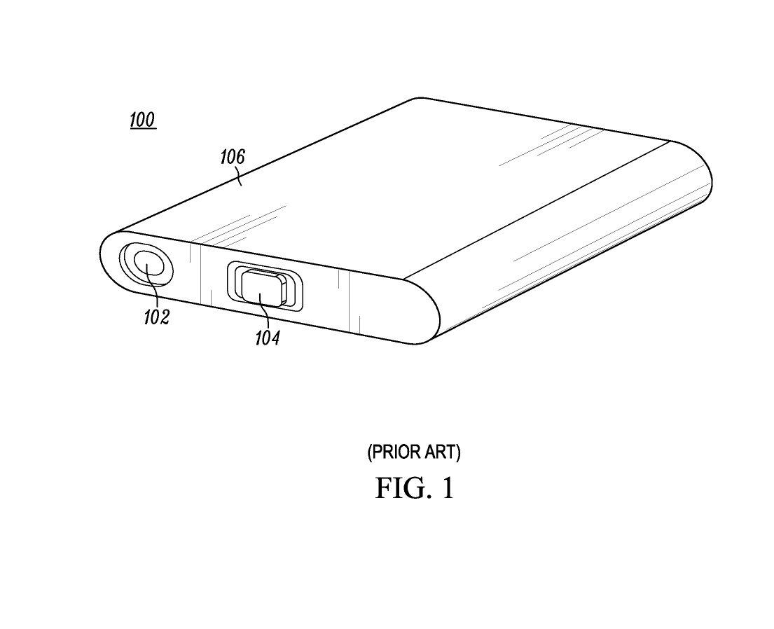

FIG. 1 is an isometric view of a battery cell 100 having a pressure vent 102, in accordance with the prior art. The battery cell 100 includes a first electrode 104 and a second electrode 106, which can be the exterior of a metal container in which the contents of the battery cell 100 are disposed (i.e. anode, cathode, separator, electrolyte). The pressure vent is designed to open when the pressure inside the battery cell 100 reaches a pre-selected pressure threshold. The pre-selected pressure threshold can be selected based on the chemistry used by the battery cell 100, as well as the particular geometry (e.g. cylindrical vs. prismatic) and volume of the battery cell. Generally, battery cells experience normal increases in pressure, such as when being charged, and in fact the battery cell container is typically designed to accommodate such typical pressure increases. The pressure threshold at which the pressure vent 102 is designed to open is selected to be higher than typical pressures experienced by ordinary use, even at the extremes of ordinary use, and assumes a fault condition has occurred inside the battery cell 100. Upon a fault condition occurring, such as an internal shorting between the anode and the cathode, pressure will rise rapidly. Upon the internal pressure of the battery cell 100 reaching the pressure threshold of the pressure vent 102, the pressure vent 102 will open, allowing gas and other material to exit the battery cell 100.

In a typical prior art battery pack, the battery cells are connected in series, anode to cathode, or in parallel combinations, and use identical cell geometries. As a result, the pressure vent of a given battery cell can be in close proximity to the container of the next battery cell in the series of battery cells. As a result, if a battery cell in a conventional arrangement vents, it can vent hot gas and material directly onto an adjacent battery cell, potentially cause that battery cell to likewise fail, leading to a thermal runaway condition of the battery.

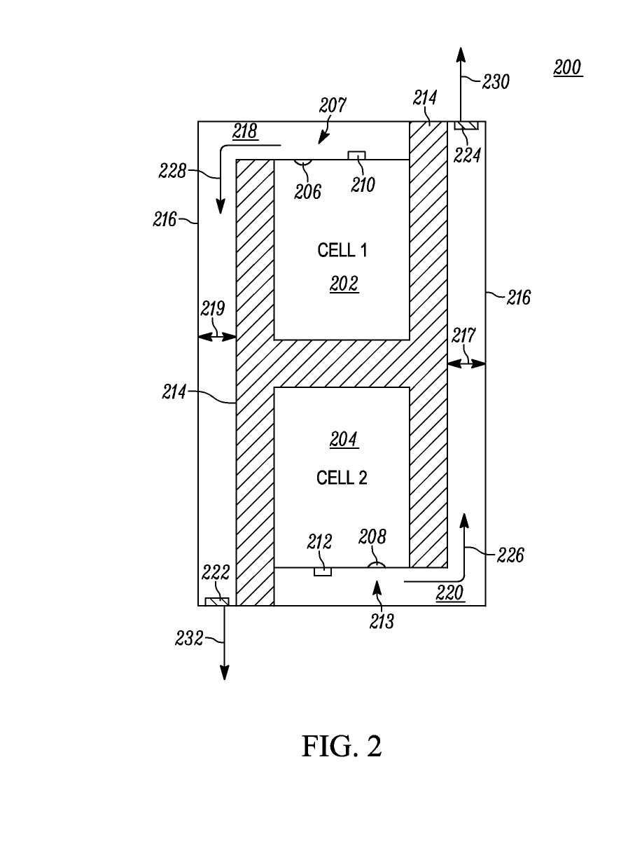

FIG. 2 is top cut-away plan view of a battery pack 200 in accordance with some embodiments. The battery pack 200 includes a first battery cell 202 and a second battery cell 204. The first battery cell 202 includes a pressure vent 206 and a positive electrode 210, and the second battery cell 204 likewise includes a pressure vent 208 and a positive electrode 212. Those skilled in the art will appreciate that although electrodes 210, 212 are referred to here as being positive electrodes, some battery cell constructions have an opposite polarity and the electrodes 210, 212 can be negative electrodes. The first and second battery cells 202, 204 are each disposed in a barrier structure 214, and are oriented such that their respective pressure vents 206, 208 are pointing in substantially opposite directions. The battery cells are electrically connected in series such that, for example, the positive terminal 210 of the first battery cell 202 is directly connected to the negative terminal (i.e. the can) of the second battery cell 204. Accordingly, the battery pack 200 can supply a voltage that is double that of a single battery cell. The electrical connection between the battery cells 202, 204 can be made by any conventional manner. The barrier structure is made of an electrically insulative and thermally resistant material that can withstand temperatures produced by the battery cells 202, 204, upon experiencing a fault condition, without substantial deformation. Examples of such material can include, for example, ceramic, ceramic-impregnated polymeric material, and cured phenol-based resin, among others known in the art. The barrier structure physically isolates the battery cells 202, 204 from each other to provide an electrical and thermal barrier between the battery cells. The barrier structure provides a vent channel 207, 213 in proximity to the respective pressure vents 206, 208, into which material vented from the battery cells 202, 204 will escape upon the pressure vents 206, 208 opening.

The barrier structure 214 is assembled into a housing that has a housing wall 216. The housing wall 216 separates the inside of the housing from the outside of the housing, and is configured to form a flow channel 218, 220, respectively, between the housing wall 216 and the barrier structure 214 from the vent channel 207, 213 of the barrier structure 214 to a housing vent 222, 224 formed in the housing wall. Thus there is a separation 217, 219 between the housing wall 216 and the barrier structure 214. Upon a battery cell 202, 204 experiencing a fault condition and venting, the hot material will escape through the pressure vent 206 or 208 into a respective vent channel 207, 213, and continue along the respective contiguous flow channel 218, 220 in the direction of respective arrows 226, 228, where the volume of the flow channels 218, 220 allows relief of the pressure. Furthermore, the vented material can further escape out of the battery pack entirely through a respective housing vent 222, 224, as indicated by respective arrows 230, 232. The housing vents can simply be openings in the housing wall 216, or they can be mechanical sealed vent mechanisms that open upon pressure in the respective flow channel 218, 220 exceeding a pressure threshold (which is lower than the pressure threshold of the battery cell pressure vents 206, 208). In some embodiments the housing vents 222, 224 can be covered with a label on the outside of the housing wall 216 that obscures the housing vents 222, 224 from view. The volume of the flow channel allows expansion of the vented material, thereby cooling the vented material. Accordingly, the housing wall material does not necessarily have to withstand the same temperatures that can be withstood by the barrier structure, but in some embodiments the housing wall 216 can be formed with thermal barriers or shields in the area of the pressure vents 206, 208.

It will be appreciated by those skilled in the art that, as shown here in FIG. 2, each of the battery cells 202, 204 has its own isolated vent channel 207, 213, and flow channel 218, 220, and that in some embodiments the battery cells 202, 204 can share a common flow channel to maximize the expansion volume into which the vented material is expelled. Furthermore, in some embodiments, the battery pack can contain a single battery cell, and the flow channel can be formed contiguously around the battery cell to maximize the expansion volume within the battery pack.

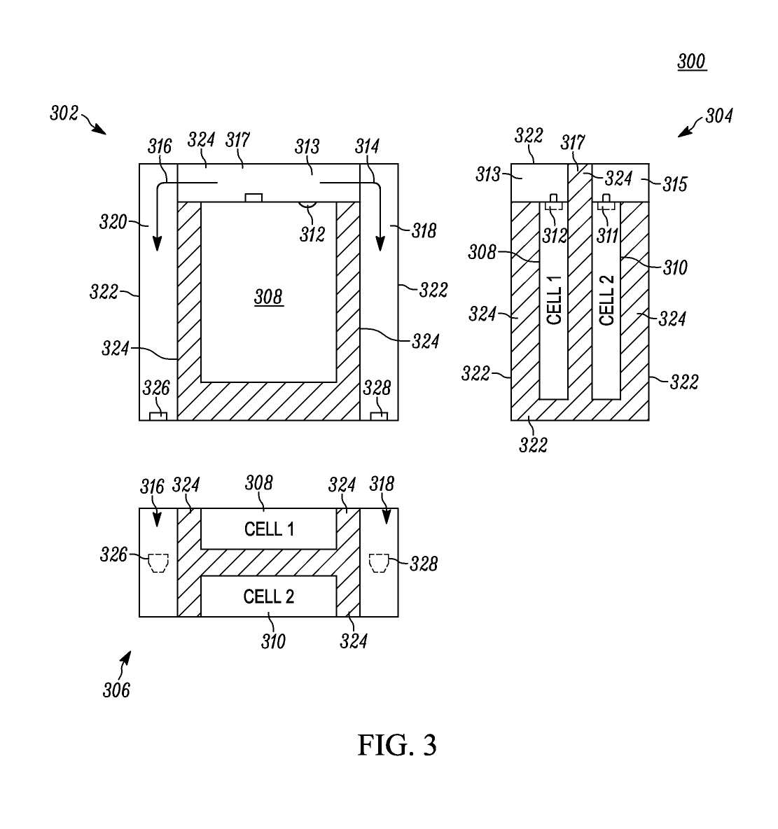

FIG. 3 is a multi-view diagram of a battery pack 300 containing commonly oriented battery cells in accordance with some embodiments. The diagram includes a top cut-away plan view 302, a side cut-away view 304, and a bottom cut-away view 306. The battery pack includes a first battery cell 308 and a second battery cell 310. The battery cells 308, 310 are commonly oriented and their respective pressure vents 312, 311 are pointed in the same direction. However, the barrier structure 324 in which the battery cells 308, 310 are disposed includes a protrusion 317 that isolates a respective vent channel 313, 315 for each of the battery cells 308, 310 from each other. The protrusion 317 prevents vented material from either cell from venting directly onto the other battery cell. The vent channels 313, 315 adjoin flow channels 320, 318 along the sides of the barrier structure 324. The flow channels 320, 318 are formed by a space between the barrier structure 324 and a housing wall 322. Material vented out of the cells travels in the direction of arrows 316, 314 where the volume of the vent channels 313, 315 and flow channels 318, 320 allow expansion of the vented gases. In the example illustrated here, the vent channels 313, 315 and flow channels 318, 320 form a contiguous volume around three sides of the battery cells 308, 310. Housing vents 326, 328 allow vented gases further expansion outside of the battery pack 300. The housing vents 326, 328 can be openings (holes) in the housing wall 322, or they can include a mechanism similar to the pressure vents 312, 311 of the battery cells 308, 310 which open upon pressure in the internal volume of the battery pack reaching a threshold.

As can be seen, the battery cells 308, 310 are physically isolated from each other. They will be electrically connected together, either in series or in parallel inside the battery pack 300 to provide voltage and current at battery contacts of the battery pack 300, as is known in the art. The barrier structure acts as both a thermal and electrical insulator, and can be formed in a variety of ways, including molding, machining, or assembly of parts.

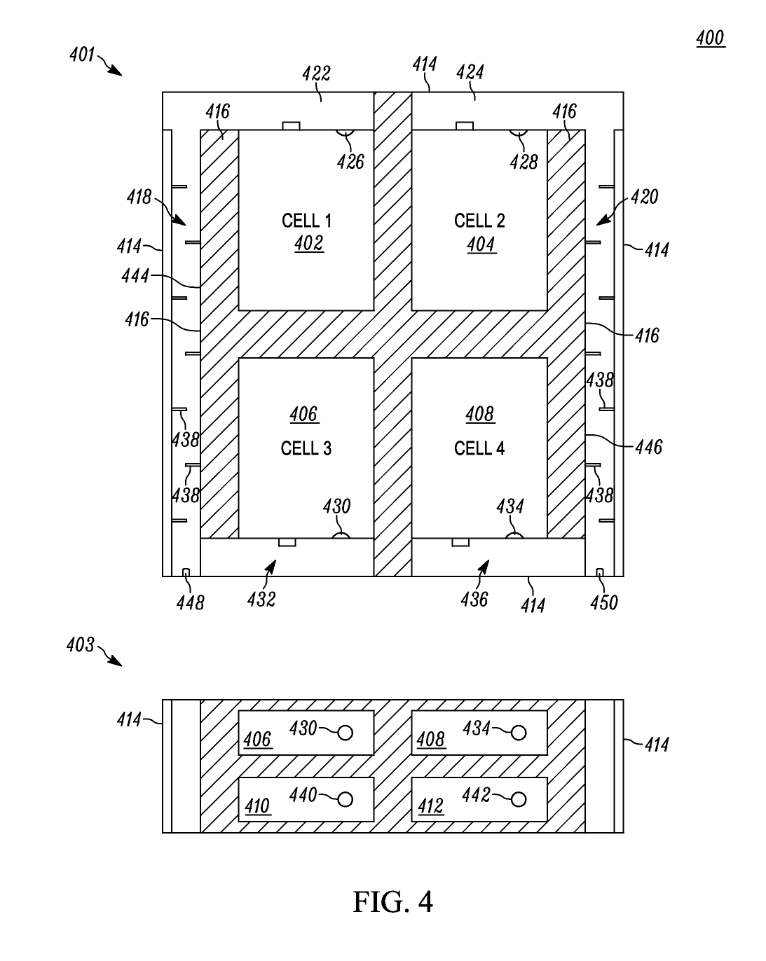

FIG. 4 is a top cut-away plan view 401 of a battery pack 400 having baffle walls in a flow channel in accordance with some embodiments. A bottom cut-away view 403 is also shown. The battery pack 400 includes eight battery cells 402, 404, 406, 408, 410, 412, six of which are shown between the two views 401, 403. The arrangement of the battery cells 402, 404, 406, 408, 410, 412 combines the arrangement of FIGS. 2-3, where some battery cells are oriented in opposite directions from each other (e.g. 402 and 406) and some are commonly oriented (e.g. 406 and 410). The battery cells all have pressure vents 426, 428, 430, 434, 440, 442, respectively. The battery cells 402, 404, 406, 408, 410, 412 are disposed in an insulative barrier structure 416 that isolates each of the battery cells 402, 404, 406, 408, 410, 412 from each other, and provides electrical and thermal insulation. The battery cells 402, 404, 406, 408, 410, 412 are electrically connected together to provide a battery voltage and a set of battery contacts, as is known.

The housing wall 414 is configured to be spaced away from the sides 444, 446 of the barrier structure 416, forming flow channels 418, 420 that are contiguous with vent channels 422, 424. Gasses and other materials that get vented out of the battery cells 402, 404, 406, 408, 410, 412 in the event of a fault expand into the vent and flow channels 418, 420, 422, 424, and can exit out of housing ports 448, 450. The housing is further configured to include a plurality of baffle walls 438 in the flow channels 418, 420. The baffle walls 438 alternate sides of the flow channels 418, 420 along the lengths of the flow channels 418, 420, and extend part-way across the flow channels 418, 420. The baffle walls 438 act to slow the escape of gasses out of the battery pack 400, and block solid material ejected from a venting battery cell so as to prevent solid matter from leaving the battery pack or potentially block a housing port 448, 450.

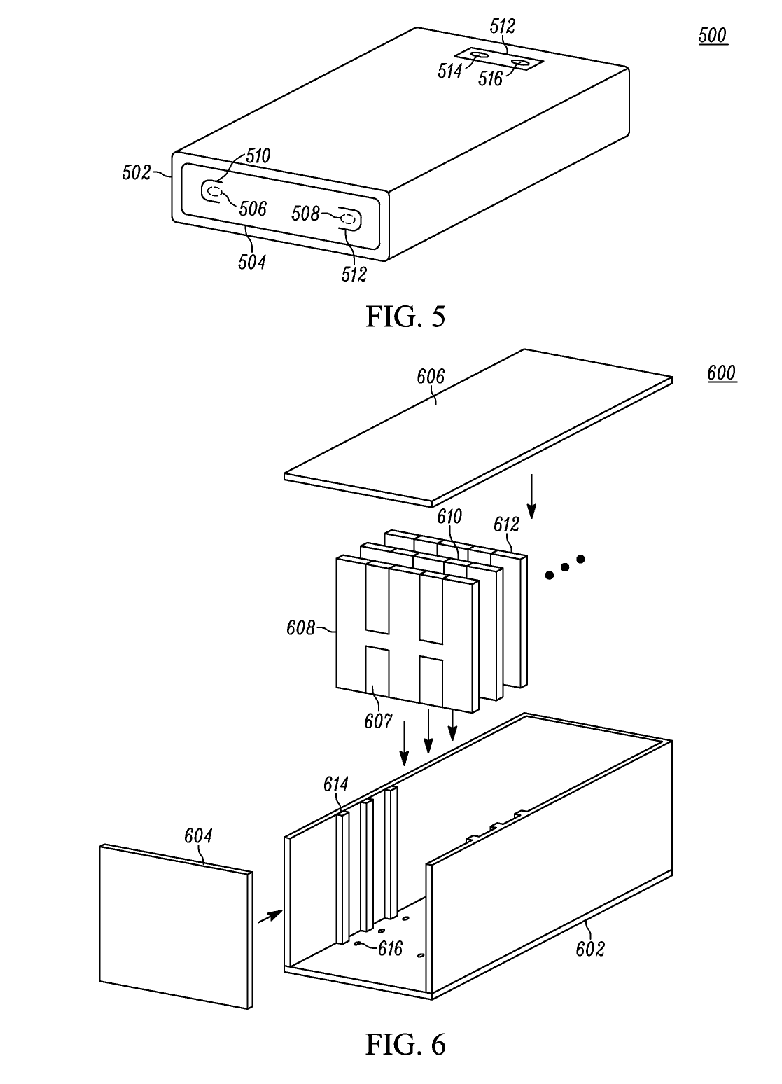

FIG. 5 is an external view of a battery pack 500 having a label 504 that covers a housing vent in accordance with some embodiments. The label is disposed over a section of the battery pack housing 502 on an external portion of the housing 502. Housing vents 506, 508 are covered by the label 504, and thereby hidden from view. In the event of a venting, pressure through the housing ports 506, 508 can lift off or partially separate the label 504 from the housing 502 to allow escape of the vented gas out of the battery pack 500. In some embodiments the label 504 can be scored 510, 512 around the respective housing vents 506, 508 to allow a portion of the label to lift off from the housing 502. Furthermore, in this particular view a set of contacts 512 are shown, including a positive battery contact 514 and a negative battery contact 516 that connect to a device to be powered by the battery pack.

FIG. 6 is battery pack 600 including a plurality of sub-units where each sub-unit includes one or more battery cells and corresponding flow channels, in accordance with some embodiments. Whereas the battery pack 200 of FIG. 2 was suitable for a portable electronic device, the battery pack 600 is intended to include a large number of battery cells electrically connected together for larger applications, such as electric vehicles and industrial applications. The battery pack 600 includes a main housing portion 602 that can be substantially tub-shaped. A front cover 604 and top cover 606 can be used to complete the outer portion of the housing. A plurality of battery sub-units 608, 610, 612 can be assembled into the housing 602, and each sub-unit 608, 610, 612 can be include a plurality of battery cells (e.g. 607) such as that shown in FIG. 4, disposed in a barrier structure. The sub-units 608, 610, 612 can be disposed in rails 614 or similar captivating features on an inside surface of the housing portion 602 that forms flow channels between the sides of the sub-units 608, 610, 612 and the housing portion 602. Housing vents 616 allow vented gases to escape outside of the battery pack 600. Accordingly, using an arrangement such as that shown in FIG. 6, a large number of battery cells can be packaged together, and a single cell, upon experiencing a fault condition, will not cause a cascade or thermal runaway event. It will be appreciated by those skilled in the art that the battery cells in the sub-units 608, 610, 612 will not be exposed as shown; they are only made visible here to indicate their inclusion in the sub-units 608, 610, 612. Furthermore, various arrangements will occur to those skilled in the art using a barrier structure and flow channels to allow venting gas to escape from a battery pack in accordance with at least some of the embodiments.

The embodiments provide the benefit of preventing a cascade or thermal runaway failure in a battery pack upon a fault condition occurring in one battery cell. Furthermore, in single cell embodiments, the use of a flow channel to allow expansion of venting gasses before they exit the battery pack in a directed manner can reduce the temperature of the venting gasses, therefore reduce the risk damage to nearby objects or injury to users.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A battery pack, comprising:
at least one battery cell having a pressure vent;
a barrier structure formed around the at least one battery cell comprised of a thermally resistant material and forming a vent channel in proximity to the pressure vent of the at least one battery cell; and
a housing in which the at least one battery cell and barrier structure are disposed and having a housing wall, wherein the housing wall is configured to form a flow channel between the housing wall and the barrier structure from the vent channel of the barrier structure to a housing vent formed in the housing wall.

2. The battery pack of claim 1, wherein the flow channel is formed between the housing wall and the barrier structure along opposing sides of the barrier structure.

3. The battery pack of claim 1, wherein the flow channel comprises a plurality of baffle walls in the flow channel.

4. The battery pack of claim 1, wherein the flow channel is a contiguous volume around the barrier structure.

5. The battery pack of claim 1, wherein the at least one battery cell comprises at least a first battery cell and a second battery cell, wherein the first and second battery cells are oriented within the barrier structure so as to be isolated from each other and such that their respective pressure vents point in substantially opposite directions, and wherein the housing wall is configured to form a separate respective flow channel for each of the first and second battery cells.

6. The battery pack of claim 1, wherein the at least one battery cell comprises at least a first battery cell and a second battery cell, wherein the first battery cell and second battery cell are commonly oriented in the barrier structure and isolated from each other by the barrier structure, and wherein the barrier structure extends from between the first and second battery cells to the housing wall to form an isolation barrier between the respective pressure vents of the first and second battery cells.

7. The battery pack of claim 1, wherein the at least one battery cell and barrier structure form a sub-unit of the battery pack, wherein the sub-unit is one of a plurality of such sub-units, and wherein each sub-unit comprises a corresponding flow channel.

8. A method of forming a battery pack, comprising:
assembling at least one battery cell having a pressure vent into a barrier structure formed of a thermally resistant material, the barrier structure having a vent channel in proximity to the pressure vent of the at least one battery cell; and
assembling the barrier structure and the at least on battery cell as a sub-assembly into a housing having a housing wall, wherein the housing wall forms a flow channel between the housing wall and the barrier structure within the housing from the vent channel of the barrier structure to a housing vent formed in the housing wall.

9. The method of claim 8, wherein assembling the sub-assembly into the housing comprises assembling the sub-assembly into the housing wherein the flow channel is formed between the housing wall and the barrier structure along opposing sides of the barrier structure.

10. The method of claim 8, wherein assembling the sub-assembly into the housing comprises assembling the sub-assembly into the housing wherein the flow channel comprises a plurality of baffle walls in the flow channel.

11. The battery pack of claim 8, wherein assembling the sub-assembly into the housing comprises assembling the sub-assembly into the housing wherein the flow channel is a contiguous volume around the barrier structure.

12. The battery pack of claim 8, wherein:
assembling the at least one battery cell into the barrier structure comprises assembling at least a first battery cell and a second battery cell into the barrier structure by orienting the first and second battery cells within the barrier structure so as to be isolated from each other and such that their respective pressure vents point in substantially opposite directions; and
wherein assembling the sub-assembly into the housing comprises assembling the sub-assembly into the housing wherein the housing wall is configured to form a separate respective flow channel for each of the first and second battery cells.

13. The method of claim 8, wherein:
assembling the at least one battery cell into the barrier structure comprises assembling at least a first battery cell and a second battery cell into the barrier structure by orienting the first battery cell and second battery cell commonly in the barrier structure and isolated from each other by the barrier structure; and
wherein the barrier structure extends from between the first and second battery cells to the housing wall to form an isolation barrier between the pressure vents of the first and second battery cells.

14. The method of claim 8, wherein assembling the at least one battery cell into barrier structure comprises forming a sub-unit of the battery pack, the method further comprises assembling a plurality of such sub-units into the housing, wherein the housing wall forms a corresponding flow channel for each respective sub-unit of the plurality of sub-units.

15. The method of claim 8, further comprising assembling an external label over the housing vent on an outside surface of the housing that obscures the housing vent, and wherein the external label yields to pressure so as not to obstruct the housing vent upon gas being vented from the housing vent.

16. A battery pack, comprising:
a barrier structure comprised of a thermally resistant material;
a first battery cell and a second battery cell disposed in the barrier structure, each of the first and second battery cells having a respective pressure vent, wherein the barrier structure thermally isolates the first and second battery cells from each other and provides a respective vent channel at the pressure vent of each of the first and second battery cells; and
a housing in which the first and second battery cells and the barrier structure are disposed, and having a housing wall, wherein the housing wall is configured to form a flow channel for each of the first and second battery cells between the housing wall and the barrier structure from the vent channel for each of the first and second battery cells to a housing vent formed in the housing wall.

17. The battery pack of claim 16, wherein the first and second battery cells are oppositely oriented in the barrier structure such that their respective pressure ports are facing away from each other.

18. The battery pack of claim 16, wherein the first battery cell and the second battery cell are commonly oriented in the barrier structure and isolated from each other by the barrier structure, and wherein the barrier structure extends from between the first and second battery cells to the housing wall to form an isolation barrier between the respective pressure vents of the first and second battery cells.

19. The battery pack of claim 16, further comprising a label disposed over the housing vent on an outside surface of the battery pack.

20. The battery pack of claim 16, further comprising a plurality of alternating baffle walls in the flow channel.
